(19) United States
(12) Patent Application Publication
(10) Pub. No.: US 2002/0189015 A1
(43) Pub. Date: Dec. 19, 2002

(54) Movable articulated bed

(75) Inventor: Isaac Barssessat, Tel Aviv (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hollandia The Sleep Engineering Center - Investment (1992) LTD, Sederot (IL)

(21) Appl. No.: 10/171,486

(22) Filed: Jun. 5, 2002

(30) Foreign Application Priority Data
Jun. 13, 2001 (IL) 143,727

(51) Int. Cl. A61G 7/08; A61G 7/015

(52) U.S. Cl. 5/620; 5/618; 5/510

(57) ABSTRACT

The invention provides an adjustable bed of the type comprising a bed base frame, having a lead end, a foot end, opposed longitudinal members connecting same end foot members attached to the base frame normally being in contact with a floor surface, an articulated moving upper frame mounted on a carriage having leg support portions and upper body support portions articulated to each other and supported on the carriage for longitudinal shifting of the support portions relative to the base frame; and motor means for raising the upper body support portion and/or the leg support portions the led further comprising at least one wheeled leg member operationally connected to the motor, the at least one leg member being displaceable from a first elevated position to a second deployed position, wherein in the second deployed position the at least one wheeled leg member is brought it in contact with the floor surface and a rolling element supported at the leg member free extremity applies a force to the floor surface sufficient to elevate therefrom at least one of the bed base frame ends, whereby the be can be easily moved while partially supported on the rolling element.

### CROSS-REFERENCES TO RELATED APPLICATIONS

Not Applicable

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK.

Not Applicable

### BACKGROUND OF THE INVENTION

### BRIEF SUMMARY OF THE INVENTION

The present invention relates to an articulating bed.

More particularly, the invention provides, for a bed carrying an electrically changeable upper structure, means for readily moving the bed on wheeled legs which are power deployed/retracted.

An articulated bed is adjustable so that the user can be brought to a sitting position, or inclined between a sitting and a lying position. Many such beds have provision for raising the foot section. Whichever mode is chosen depends on the doctor's recommendation, and on the patient's condition. Bed configuration can be adjusted using lead screws, which in modern beds are electrically driven. Such beds are in widespread use in hospitals and in homes for the elderly.

In addition there is an increasing market for articulated beds for private home use, wherein the bed can be changed from a horizontal orientation for sleep to a sitting position providing proper back and head support for reading, for social interaction and other situations in which the user while still in bed does not wish to remain in a prone position. The provision of convenient motor control allows the user him/herself to change the bed configuration.

Many improvements have been proposed for beds of this type. The state of the art can best be gauged from recent patent disclosures, including European Patent No. EP 0 884 011 A1, and U.S. Pat. Nos. 6,006,379; 6,058,532; 6,076,210; 6,088,853; 6,101,649; 6,108,839 and 6,112,345.

A requirement to which no attention has been given, to the knowledge of the present inventor, is that such beds sometimes need to be moved for room cleaning or for other purposes. The weight of a typical articulated bed, when unoccupied, is about 70-90 kg. Moving the bed is thus difficult, particularly for women, and is impossible for most elderly people.

Some hospital-type beds are fitted with four wheels underneath the bed frame, so that the bed can be moved, whether empty or occupied, to another department. However wheeled beds tend to move when stability is required, such as when the user enters or leaves the bed. Regarding a bed for home use, the 4 wheels do not present an esthetic appearance.

It is therefore one of the objects of the present invention to obviate the disadvantages of prior art articulated beds and to provide a mechanism which allows the bed to be readily moved when required and to remain stationary at other times.

It is a further object of the present invention to provide a mechanism that enables the bed to be moved or maneuvered and turned by a person with little physical strength.

It is yet a further object of the present invention to provide powered wheeled leg deploymer/retraction utilizing the motor that is already provided for changing the configuration of the plates supporting the mattress.

The present invention achieves the above objects by providing an adjustable bed of the type comprising:

a) a bed base frame, having a head end, a foot end, opposed longitudinal members connecting same and foot members attached to the base frame normally being in contact with a floor surface;

b) an articulated moving upper frame mounted on a carriage having leg support portions and upper body support portions articulated to each other and supported on the carriage for longitudinal shifting of the support portions relative to the base frame; and

c) motor means for raising the upper body support portion and/or the leg support portion.

The bed further comprises at least one wheeled leg member operationally connected to the motor, the at least one leg member being displaceable from a first elevated position to a second deployed position. In the second deployed position the at least one wheeled leg member is brought into contact with the floor surface and a rolling element supported at the leg member free extremity applies a force to the floor surface sufficient to elevate therefrom at least one of the bed base frame ends, whereby the bed can be easily moved while partially supported on the rolling element.

In a preferred embodiment of the present invention there is provided an adjustable bed wherein the at least one wheeled leg member comprises a pair of spaced-apart leg members, each carrying a rolling element at its free extremity.

In a most preferred embodiment of the present invention there is provided an adjustable bed wherein the leg members are positioned to be brought into contact with the floor surface in an area substantially intersecting a vertical plane of the center of gravity of the bed.

Yet further embodiments of the invention will be described hereinafter.

It will thus be realized that the novel bed of the present invention, although intended primarily for short movements, can also be arranged so that the rolling element—wheel, roller or ball at the leg(s) free extremity is made sturdily enough to also allow hospital staff to transfer the bed between departments.

During the employment of the wheeled leg(s) the articulated plates underneath the mattress are horizontal and form a flat surface. This however is not a major limitation as the bed of the present invention is generally intended to be moved either when unoccupied or when occupied by a prone patient.

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

FIG. 1 is an elevational view of a preferred embodiment of the bed according to the invention, the leg being shown retracted;

FIG. 2 is an elevational view of the same embodiment of the bed the leg being shown deployed;

FIG. 3 is an end elevational view of the same embodiment showing further details;

FIG. 4 is an end elevational view of an embodiment provided with two wheeled leg members;

FIG. 5 is an end elevational view of an embodiment provided with two spherical rollers supporting the leg members; and

FIG. 6 is an elevational view of a further embodiment of the bed.

### DETAILED DESCRIPTION OF THE INVENTION

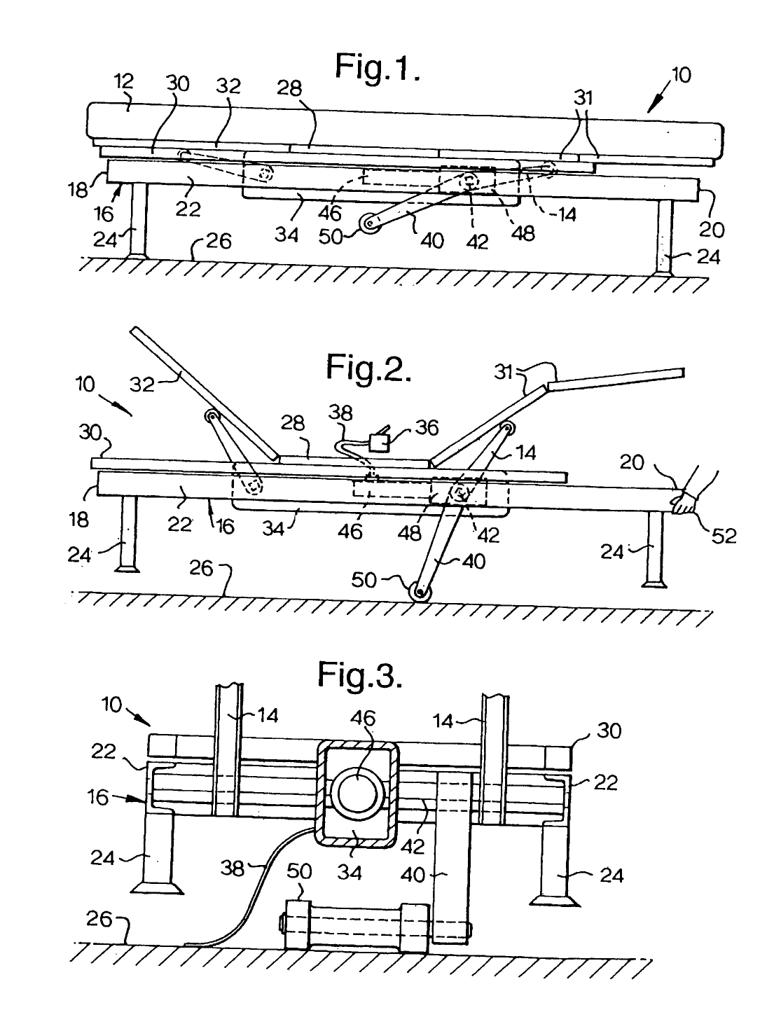

There is seen in FIGS. 1, 2 and 3 an adjustable bed 10 of the type where parts of the mattress 12 can be raised by means of a motor operated tilt mechanism 14.

A bed base frame 16, has a head end 18, a foot end 20, opposed longitudinal members 22 connecting the ends 18, 20 and four foot members 24 which are attached to the base frame 16 and are normally in contact with a floor surface 26 to support the bed 10.

An articulated moving upper plate frame 28 to support a mattress 12 is mounted on a carriage 30. The frame 28 has patient leg support portions 31 and upper body support portions 32 each connected by hinges to one or two of the other pieces. The carriage 30 allows longitudinal shifting of the support frame 28 relative to the base frame 16.

A reversible electric motor 46 and speed reducer 48 are contained in a housing 34, these components being connected for raising the upper body support portion 32 and/or the leg support portions 31. Forward/reverse motor controls 36 are provided connected to a flexible cable 38 for use of the patient or attendant. A bed matching this description is disclosed in my co-pending application Israel Patent Application No. 138,968/2.

Referring now to FIG. 3, the bed 10 of the present invention further comprises a wheeled leg member 40 operationally connected to the motor 46. The wheeled leg 40 seen is mounted on and rotationally driven by a square shaft 42, which also drives the tilt mechanism 14 of the upper body support portions 32. The leg 40 is displaceable from a first elevated position as seen in FIG. 1 to a second deployed position as in FIG. 2 by operating the electric motor.

In the leg retracted position seen in FIG. 1, the mechanism 14 used to raise the head and foot portions 31, 32 of the frame 28 breaks contact with the mattress support frame 28 which was previously raised. The frame 28 then takes up a horizontal position in a plane proximate to the top of the carriage 30.

Continuous operation of the motor 34 brings the leg member 40 into contact with the floor surface 26 through a rolling element, which in the present embodiment is a roller 50. The roller 50 provides stability and prevents the bed tipping sideways.

The roller 50 revolvably supported at the leg member free extremity 52, and applies a force to the floor surface 26 sufficient to elevate therefrom at least one of the bed base frame ends 18, 20. The roller 50 is suitably made of a polyamide resin, which requires no added bearings or lubrication. Advantageously the leg member 40 is positioned so that the roller 50 is brought into contact with the floor surface 26 in an area substantially intersecting a vertical plane of the center of gravity of the bed.

The bed 10 can now be easily moved while over 90% of its weight is supported on the roller 50. Thereafter either the foot end or the head end 18, 20 of the bed frame can be grasped by hand 52 for purposes of manipulation.

The diameter of the roller 50 can be selected according to the intended use of the bed. For hospital use, where it may be required to transfer a bed between departments, or to traverse an elevator step, a suitable roller diameter is between 100 and 150 mm. For home use, where the bed is likely to be moved only a short distance for purposes of room cleaning, 50-70 mm diameter is adequate.

With regard to the rest of the figures, similar reference numerals have been used to identify similar parts.

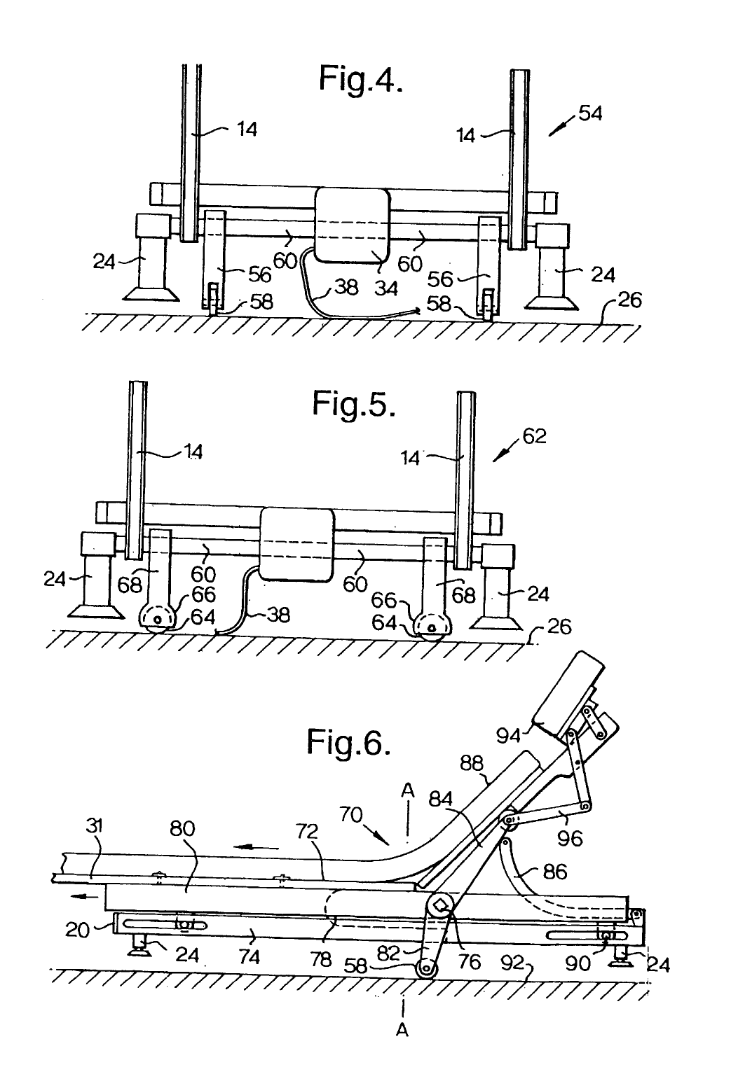

Referring now to FIG. 4, there is seen an adjustable bed 54 wherein two spaced-apart wheeled leg members 56 support the bed when deployed. Each leg carries a wheel 58 at its free extremity. For hospital use the wheel can be rubber tired to reduce noise when in use.

Both legs members 56 are rigidly attached to the motor-driven square shaft 60 which serve also for changing the bed configuration. The spaced-apart legs members 56 provide improved stability when deployed, which is not possible with fixed axis wheels.

FIG. 5 illustrate a detail of an adjustable bed 62, wherein the rolling element is a ball 64 revolvably supported in a bearing socket 66 at the free extremity of each leg member 68. The balls 64 are made of a strong low-friction material such as acetal or polyamide, and are advantageous in allowing the bed 62 to easily moved in any desired direction, including sideways.

Seen in FIG. 6 as an adjustable bed 70 wherein the motor 46, seen in FIG. 2, drives linkages for displacement of the upper frame 72 of the bed relative to the bed base frame 74.

The square drive bar 76 and the motor housing 78 are mounted on the slideable carriage 80. When the leg members 82 are deployed, the lever 84 is in a raised position. A curved link 86 which is anchored to the base frame 74 at its right extremity has drawn the lever 84, and with it the carriage 80 carrying the mattress 88, over to the right as seen in the figure, to near the end of the carriage movement 90.

The leg members 82 are arranged so that when deployed on a floor surface area 92 substantially intersecting a vertical plane “AA” of the center of gravity of the bed, as the bed 70 is configured at the time of leg deployment. Thus a person grasping any end of the bed is not required to lift any substantial load. The figure also shows a headrest 94 and a mechanism 96 for its operation.

While not shown, it is possible to provide the bed with a first leg member 82 adjacent the head area of the bed as shown in FIG. 6 and a second leg member 40 adjacent the foot end 20 as shown in FIG. 2, both linked to the motor 46, whereby both can be simultaneously deployed for movement of a bed even with a patient therein.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. An adjustable bed of the type comprising:
a) a bed base frame, having a head end, a foot end, opposed longitudinal members connecting same and foot members attached to said base frame normally being in contact with a floor surface;
b) an articulated moving upper frame mounted on a carriage having leg support portions and upper body support portions articulated to each other and supported on said carriage for longitudinal shifting of said support portions relative to said base frame; and
c) motor means for raising said upper body support portion and/or said leg support portion;
said bed further comprising at least one wheeled leg member operationally connected to said motor, said at least one leg member being displaceable from a first elevated position to a second deployed position, wherein in said second deployed position said at least one wheeled leg member is brought into contact with said floor surface and a rolling element supported at the leg member free extremity applies a force to said floor surface sufficient to elevate therefrom at least one of said bed base frame ends, whereby said bed can be easily moved while partially supported on said rolling element.

2. An adjustable bed according to claim 1, wherein said at least one wheeled leg member comprises a pair of spaced-apart leg members, each carrying a rolling element t its free extremity.

3. An adjustable bed according to claim 1, wherein said rolling element is at least one wheel.

4. An adjustable bed according to claim 1, wherein said rolling element is a roller.

5. An adjustable bed according to claim 1, wherein said rolling element is at least one ball.

6. An adjustable bed according to claim 2, wherein said leg members are positioned to be brought into contact with said floor surface in an area substantially intersecting a vertical plane of the center of gravity of said bed.

7. An adjustable bed according to claim 2, wherein said motor is provided with linkages for displacement of said upper frame of said bed relative to said bed base frame so that said leg members are deployed on a floor surface area substantially intersecting a vertical plane of the center of gravity of said bed.
